(19) United States
(12) Patent Application Publication
(10) Pub. No.: US 2025/0346803 A1
(43) Pub. Date: Nov. 13, 2025

(54) FRACTURING FLUID COMPOSITIONS WITH OXIDIZERS AND NANOPARTICLES AND RELATED METHODS

(71) Applicant: Saudi Arabian Oil Company, Dhahran (SA)

(72) Inventors: Hassan Alqahtani, Dammam (SA); Murtadha J. AlTammar, Dhahran (SA); Khalid Mohammed M. Alruwaili, Dhahran (SA); Katherine Leigh Hull, Houston, TX (US); Younane N. Abousleiman, Norman, OK (US)

(21) Appl. No.: 18/658,304

(22) Filed: May 8, 2024

(51) Int. Cl. C09K 8/70

(52) U.S. Cl. CPC C09K 8/70; E21B 43/26; C09K 2208/10

(57) ABSTRACT

The disclosure relates to compositions and methods that include fluid compositions that include nanoparticles and an oxidizer. The fluid compositions can be used as hydraulic fracturing fluids during drilling operations.

### FIELD

The disclosure relates to compositions and methods that include fluid compositions that include nanoparticles and an oxidizer. The fluid compositions can be used as hydraulic fracturing fluids during drilling operations.

### BACKGROUND

Hydraulic fracturing is the high pressure pumping of a fracturing fluid into a rock formation to create cracks, or fractures, to stimulate the production of an oil or gas well.

Fracturing is used to increase the production rate in many rock formations, and make the development of many wells economical. Further, hydraulic fracturing has enabled the production of hydrocarbons from unconventional resources such as shale gas, shale oil, and coal bed methane.

### SUMMARY

The disclosure relates to compositions and methods that include fluid compositions that include nanoparticles and an oxidizer. The fluid compositions can be used as hydraulic fracturing fluids during drilling operations.

The compositions and methods can increase the porosity of a rock formations relative to certain other compositions and methods.

The compositions and methods can increase the channel connectivity of the rock formations relative to certain other compositions and methods.

The compositions and methods can increase the surface area of the rock formations relative to certain other compositions and methods.

The compositions and methods can increase the increase the production rate of hydrocarbons from the rock formations relative to certain other compositions and methods.

The compositions and methods can increase the permeability of the composition within rock formations relative to certain other compositions and methods.

The methods may involve fewer processing steps to form fractures in rock formations relative to certain other compositions and methods for forming fractures in rock formations.

In a first aspect, the disclosure provides a composition, including nanoparticles and an oxidizer, wherein the composition is a fluid.

In some embodiments, the nanoparticles are uncrosslinked.

In some embodiments, the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), and cadmium oxide (CdO).

In some embodiments, the nanoparticles comprise silica.

In some embodiments, the composition comprises 0.1 wt % to 10.0 wt % nanoparticles.

In some embodiments, the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

In some embodiments, the oxidizer comprises at least one member selected from the group consisting of a hypochlorite, a chlorite, a chlorate, a perchlorate, a hypobromite, a bromite, a bromate, and a perbromate.

In some embodiments, the oxidizer comprises at least one member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, Ba(BrO₃)₂, F₂, Cl₂, MgO₂, CaO₂, NaNO₂, NaNO₃, Na₂S₂O₈, Na₂B₄O₇, Na₂H₃CO₆, H₂O₂, NaClO, Ca(IO₃)₂, KIO₃, KH(IO₃)₂, NaIO₄, KIO₄, Na₂CrO₄, Na₂Cr₂O₇, K₂Cr₂O₇, NaMnO₄, and KMnO₄.

In some embodiments, the oxidizer comprises at least one member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, and Ba(BrO₃)₂.

In some embodiments, the oxidizer has a standard reduction potential of greater than 0.40 volts (V). In some embodiments, the oxidizer has a standard reduction potential of 0.40 V to 3.00 V. In some embodiments, the oxidizer has a standard reduction potential of 0.50 V to 2.00 V.

In some embodiments, the composition comprises 1 pounds per thousand gallons (pptg) to 100 pptg oxidizer. In some embodiments, the composition comprises 10 pptg to 50 pptg oxidizer.

In some embodiments, the composition is slickwater-based, linear gel-based, viscoelastic surfactant-based, or polymer-based gel-based.

In some embodiments, the composition comprises 0.1 wt % to 10.0 wt % silica nanoparticles and 10 pptg to 50 pptg oxidizer, wherein the oxidizer comprises a member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, and Ba(BrO₃)₂.

In a second aspect, the disclosure provides a method, including injecting the composition according to the disclosure into a rock formation to form fractures in the rock formation.

In some embodiments, the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), cadmium oxide (CdO); and the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

In a third aspect, the disclosure provides a method, including blending an oxidizer into a first fluid to form a fluid comprising an oxidizer; blending nanoparticles into a second fluid to form a fluid comprising nanoparticles; injecting the fluid comprising an oxidizer and the fluid comprising nanoparticles into a rock formation to form the composition; and creating fractures in the rock formation.

In some embodiments, the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), cadmium oxide (CdO); and the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

### DETAILED DESCRIPTION

The disclosed compositions comprise nanoparticles and an oxidizer.

In some embodiments, the nanoparticles comprise at least one member selected from silica, titanium oxide (TiO₂), zinc oxide (ZnO), aluminum oxide (Al₂O₃), cerium oxide (CeO₂), iron (III) oxide (Fe₂O₃), silver oxide (AgO), magnesium oxide (MgO), nickel oxide (NiO), zirconium oxide (ZrO), and cadmium oxide (CdO).

In some embodiments, the nanoparticles comprise silica. In some embodiments, the nanoparticles comprise titanium oxide (TiO₂). In some embodiments, the nanoparticles comprise zinc oxide (ZnO). In some embodiments, the nanoparticles comprise aluminum oxide (Al₂O₃). In some embodiments, the nanoparticles comprise cerium oxide (CeO₂). In some embodiments, the nanoparticles comprise iron (III) oxide (Fe₂O₃). In some embodiments, the nanoparticles comprise silver oxide (AgO). In some embodiments, the nanoparticles comprise magnesium oxide (MgO). In some embodiments, the nanoparticles comprise nickel oxide (NiO). In some embodiments, the nanoparticles comprise zirconium oxide (ZrO). In some embodiments, the nanoparticles comprise cadmium oxide (CdO).

In some embodiments, the composition comprises about 0.01 wt % to about 20.0 wt % nanoparticles. In some embodiments, the composition comprises about 0.05 wt % to about 15.0 wt % nanoparticles. In some embodiments, the composition comprises about 0.1 wt % to about 10.0 wt % nanoparticles. In some embodiments, the composition comprises about 1.0 wt % to about 10.0 wt % nanoparticles. In some embodiments, the composition comprises about 1.5 wt % to about 8.0 wt % nanoparticles. In some embodiments, the composition comprises about 2.0 wt % to about 6.0 wt % nanoparticles. In some embodiments, the composition comprises about 3.0 wt % to about 5.0 wt % nanoparticles.

In some embodiments, the composition comprises about 0.01 wt % to about 10.0 wt % nanoparticles. In some embodiments, the composition comprises about 0.05 wt % to about 8.0 wt % nanoparticles. In some embodiments, the composition comprises about 0.1 wt % to about 6.0 wt % nanoparticles. In some embodiments, the composition comprises about 0.5 wt % to about 4.0 wt % nanoparticles. In some embodiments, the composition comprises about 1.0 wt % to about 3.0 wt % nanoparticles.

In some embodiments, the composition comprises about 0.01 wt % to about 15.0 wt % nanoparticles. In some embodiments, the composition comprises about 0.01 wt % to about 10.0 wt % nanoparticles. In some embodiments, the composition comprises about 0.01 wt % to about 8.0 wt % nanoparticles. In some embodiments, the composition comprises about 0.01 wt % to about 6.0 wt % nanoparticles. In some embodiments, the composition comprises about 0.01 wt % to about 5.0 wt % nanoparticles. In some embodiments, the composition comprises about 0.01 wt % to about 4.0 wt % nanoparticles. In some embodiments, the composition comprises about 0.01 wt % to about 3.0 wt % nanoparticles. In some embodiments, the composition comprises about 0.01 wt % to about 2.0 wt % nanoparticles. In some embodiments, the composition comprises about 0.01 wt % to about 1.0 wt % nanoparticles.

In some embodiments, the nanoparticles are uncrosslinked.

The disclosed compositions comprise an oxidizer. Suitable oxidizers may be selected based on different properties, including their standard reduction potential (redox potential) and activation temperature.

Redox potential (oxidation/reduction potential, ORP, pe, E_{red}, or Eₕ) is a measure of the tendency of a chemical species to acquire electrons from an electrode and be reduced, or to lose electrons to an electrode to be oxidized. Each chemical species has its own intrinsic redox potential. Redox potential is expressed in volts (V). Standard reduction potential is a measure of the tendency of a chemical species to acquire electrons from an electrode and be reduced under standard conditions: T=298.15 K (25° C.), a unity activity (a=1) for each ion participating into the reaction, a partial pressure of 1 atm (1.013 bar) for each gas taking part into the reaction, and metals in their pure state. The more positive the standard reduction potential, the greater the species' affinity for electrons and tendency to be reduced. Oxidizers having positive standard reduction potentials may be suitable for the disclosed compositions. Table 1 shows standard reduction potentials for select oxidizers.

TABLE 1
Standard reduction potentials for select oxidizers

| | Standard Reduction |
|---|---|
| Half Reaction | Potential (V) |
| O₂ + 2H₂O + 4e⁻ → 4OH⁻ | +0.40 |
| BrO₃⁻ + 3H₂O + 6e⁻ → Br⁻ + 6OH⁻ | +0.58 |
| BrO⁻ + H₂O + 2e⁻ → Br⁻ + 2OH⁻ | 0.77 |
| ClO₂⁻ + 2H₂O + 2e⁻ → Cl⁻ + 4OH⁻ | +0.78 |
| ClO⁻ + H₂O + 2e⁻ → Cl⁻ + 2OH⁻ | +0.89 |
| NO₃⁻ + 3H⁺ + 2e⁻ → HNO₂ + H₂O | +0.94 |
| HNO₂ + H⁺ + e⁻ → NO + H₂O | +1.00 |
| Br₂ + 2e⁻ → 2Br⁻ | +1.09 |
| IO₃⁻ + 6H⁺ + 5e⁻ → 0.5I₂ + 3H₂O | +1.20 |
| Cr₂O₇²⁻ + 14H⁺ + 6e⁻ → 2Cr³⁺ + 7H₂O | +1.33 |
| Cl₂ + 2e⁻ → 2Cl⁻ | +1.36 |
| ClO₄⁻ + 4H₂O + 8e⁻ → Cl⁻ + 8OH⁻ | +1.42 |
| H₂O₂ + 2H⁺ + 2e⁻ → 2H₂O | +1.78 |
| ClO₃⁻ + 6H⁺ + 6e⁻ → Cl⁻ + 3H₂O | +1.45 |
| MnO₄⁻ + 4H⁺ + 3e⁻ → MnO₂ + 2H₂O | +1.70 |
| S₂O₈²⁻ + 2e⁻ → 2SO₄⁻ | +1.96 |
| F₂ + 2e⁻ → 2F⁻ | +2.87 |

The activation temperature of the oxidant corresponds to the minimum temperature of the system (e.g., a rock formation) for the oxidant to gain electrons, and thus be reduced. Oxidizers having activation temperatures that are lower than the temperature of the rock formation, for example oxychlorine oxidizers and oxybromine oxidizers, may be suitable for the disclosed compositions. However, oxidizers that can be activated at very low temperatures such as room temperature may activate too readily and decompose before reaching the rock formation.

In some embodiments, the oxidizer comprises at least one member selected from a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate. In some embodiments, the oxidizer comprises at least one member selected from a hypochlorite, a chlorite, a chlorate, a perchlorate, a hypobromite, a bromite, a bromate, and a perbromate. In some embodiments, the oxidizer comprises at least one member selected from a chlorite, a chlorate, a bromite, and a bromate. In some embodiments, the oxidizer comprises at least one member selected from a chlorite and a bromate.

In some embodiments, the oxidizer comprises a hypochlorite. In some embodiments, the oxidizer comprises a chlorite. In some embodiments, the oxidizer comprises a chlorate. In some embodiments, the oxidizer comprises a perchlorate. In some embodiments, the oxidizer comprises a hypobromite. In some embodiments, the oxidizer comprises a bromite. In some embodiments, the oxidizer comprises a bromate. In some embodiments, the oxidizer comprises a perbromate. In some embodiments, the oxidizer comprises a peroxide. In some embodiments, the oxidizer comprises a nitrite. In some embodiments, the oxidizer comprises a nitrate. In some embodiments, the oxidizer comprises a persulfate. In some embodiments, the oxidizer comprises a tetraborate. In some embodiments, the oxidizer comprises a percarbonate. In some embodiments, the oxidizer comprises a hypochlorite. In some embodiments, the oxidizer comprises an iodate. In some embodiments, the oxidizer comprises a periodate. In some embodiments, the oxidizer comprises a chromate. In some embodiments, the oxidizer comprises a dichromate. In some embodiments, the oxidizer comprises a permanganate.

In some embodiments, the oxidizer comprises at least one member selected from LiClO₂, NaClO₂, KClO₂, Mg(ClO₂)₂, Ca(ClO₂)₂, Sr(ClO₂)₂, Ba(ClO₂)₂, LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, Ba(BrO₃)₂, F₂, Cl₂, MgO₂, CaO₂, NaNO₂, NaNO₃, Na₂S₂O₈, Na₂B₄O₇, Na₂H₃CO₆, H₂O₂, NaClO, Ca(IO₃)₂, KIO₃, KH(IO₃)₂, NaIO₄, KIO₄, Na₂CrO₄, Na₂Cr₂O₇, K₂Cr₂O₇, NaMnO₄, and KMnO₄. In some embodiments, the oxidizer comprises at least one member selected from LiClO₂, NaClO₂, KClO₂, Mg(ClO₂)₂, Ca(ClO₂)₂, Sr(ClO₂)₂, Ba(ClO₂)₂, LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, Ba(BrO₃)₂, and NaClO. In some embodiments, the oxidizer comprises at least one member selected from LiClO₂, NaClO₂, KClO₂, Mg(ClO₂)₂, Ca(ClO₂)₂, Sr(ClO₂)₂, Ba(ClO₂)₂, LiBrO₃, NaBrO₃, KBrO₃, Mg(BrO₃)₂, Ca(BrO₃)₂, Sr(BrO₃)₂, and Ba(BrO₃)₂. In some embodiments, the oxidizer comprises at least one member selected from LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, and Ba(BrO₃)₂. In some embodiments, the oxidizer comprises at least one member selected from LiClO₂, NaClO₂, KClO₂, Mg(ClO₂)₂, Ca(ClO₂)₂, Sr(ClO₂)₂, and Ba(ClO₂)₂. In some embodiments, the oxidizer comprises at least one member selected from LiClO₃, NaClO₃, KClO₃, Mg(ClO₃)₂, Ca(ClO₃)₂, Sr(ClO₃)₂, Ba(ClO₃)₂. In some embodiments, the oxidizer comprises at least one member selected from LiBrO₃, NaBrO₃, KBrO₃, Mg(BrO₃)₂, Ca(BrO₃)₂, Sr(BrO₃)₂, and Ba(BrO₃)₂.

In some embodiments, the oxidizer comprises LiClO₃. In some embodiments, the oxidizer comprises NaClO₃. In some embodiments, the oxidizer comprises KClO₃. In some embodiments, the oxidizer comprises Mg(ClO₃)₂. In some embodiments, the oxidizer comprises Ca(ClO₃)₂. In some embodiments, the oxidizer comprises Sr(ClO₃)₂. In some embodiments, the oxidizer comprises Ba(ClO₃)₂. In some embodiments, the oxidizer comprises LiBrO₃. In some embodiments, the oxidizer comprises NaBrO₃. In some embodiments, the oxidizer comprises KBrO₃. In some embodiments, the oxidizer comprises Mg(BrO₃)₂. In some embodiments, the oxidizer comprises Ca(BrO₃)₂. In some embodiments, the oxidizer comprises Sr(BrO₃)₂. In some embodiments, the oxidizer comprises Ba(BrO₃)₂. In some embodiments, the oxidizer comprises F₂. In some embodiments, the oxidizer comprises Cl₂. In some embodiments, the oxidizer comprises MgO₂. In some embodiments, the oxidizer comprises CaO₂. In some embodiments, the oxidizer comprises NaNO₂. In some embodiments, the oxidizer comprises NaNO₃. In some embodiments, the oxidizer comprises Na₂S₂O₈. In some embodiments, the oxidizer comprises Na₂B₄O₇. In some embodiments, the oxidizer comprises Na₂H₃CO₆. In some embodiments, the oxidizer comprises H₂O₂. In some embodiments, the oxidizer comprises NaClO. In some embodiments, the oxidizer comprises Ca(IO₃)₂. In some embodiments, the oxidizer comprises KIO₃. In some embodiments, the oxidizer comprises KH(IO₃)₂. In some embodiments, the oxidizer comprises NaIO₄. In some embodiments, the oxidizer comprises KIO₄. In some embodiments, the oxidizer comprises Na₂CrO₄. In some embodiments, the oxidizer comprises Na₂Cr₂O₇. In some embodiments, the oxidizer comprises K₂Cr₂O₇. In some embodiments, the oxidizer comprises NaMnO₄. In some embodiments, the oxidizer comprises KMnO₄.

In some embodiments, the oxidizer has a standard reduction potential of greater than about 0.40 V. In some embodiments, the oxidizer has a standard reduction potential of greater than about 0.60 V. In some embodiments, the oxidizer has a standard reduction potential of greater than about 0.80 V. In some embodiments, the oxidizer has a standard reduction potential of greater than about 1.00 V. In some embodiments, the oxidizer has a standard reduction potential of greater than about 1.20 V. In some embodiments, the oxidizer has a standard reduction potential of greater than about 1.40 V. In some embodiments, the oxidizer has a standard reduction potential of greater than about 1.60 V. In some embodiments, the oxidizer has a standard reduction potential of greater than about 1.80 V. In some embodiments, the oxidizer has a standard reduction potential of greater than about 2.00 V. In some embodiments, the oxidizer has a standard reduction potential of greater than about 2.20 V. In some embodiments, the oxidizer has a standard reduction potential of greater than about 2.40 V. In some embodiments, the oxidizer has a standard reduction potential of greater than about 2.60 V. In some embodiments, the oxidizer has a standard reduction potential of greater than about 2.80 V.

In some embodiments, the oxidizer has a standard reduction potential of about 0.60 V to about 3.00 V. In some embodiments, the oxidizer has a standard reduction potential of about 0.80 V to about 3.00 V. In some embodiments, the oxidizer has a standard reduction potential of about 1.20 V to about 3.00 V. In some embodiments, the oxidizer has a standard reduction potential of about 1.40 V to about 3.00 V. In some embodiments, the oxidizer has a standard reduction potential of about 1.60 V to about 3.00 V. In some embodiments, the oxidizer has a standard reduction potential of about 1.80 V to about 3.00 V. In some embodiments, the oxidizer has a standard reduction potential of about 2.00 V to about 3.00 V. In some embodiments, the oxidizer has a standard reduction potential of about 2.20 V to about 3.00 V. In some embodiments, the oxidizer has a standard reduction potential of about 2.40 V to about 3.00 V. In some embodiments, the oxidizer has a standard reduction potential of about 2.60 V to about 3.00 V. In some embodiments, the oxidizer has a standard reduction potential of about 2.80 V to about 3.00 V.

In some embodiments, the oxidizer has a standard reduction potential of about 0.40 V to about 3.00 V. In some embodiments, the oxidizer has a standard reduction potential of about 0.60 V to about 2.80 V. In some embodiments, the oxidizer has a standard reduction potential of about 0.80 V to about 2.60 V. In some embodiments, the oxidizer has a standard reduction potential of about 1.00 V to about 2.40 V. In some embodiments, the oxidizer has a standard reduction potential of about 1.20 V to about 2.20 V. In some embodiments, the oxidizer has a standard reduction potential of about 1.40 V to about 2.00 V. In some embodiments, the oxidizer has a standard reduction potential of about 1.60 V to about 1.80 V. In some embodiments, the oxidizer has a standard reduction potential of about 0.50 V to about 2.00 V.

In some embodiments, the oxidizer has an activation temperature of under about 100° C. In some embodiments, the oxidizer has an activation temperature of over about 100° C. and less than about 150° C. In some embodiments, the oxidizer has an activation temperature over about 150° C.

In some embodiments, the oxidizer has an activation temperature of about 20° C. to about 150° C. In some embodiments, the oxidizer has an activation temperature of about 30° C. to about 150° C. In some embodiments, the oxidizer has an activation temperature of about 40° C. to about 150° C. In some embodiments, the oxidizer has an activation temperature of about 50° C. to about 150° C. In some embodiments, the oxidizer has an activation temperature of about 60° C. to about 150° C. In some embodiments, the oxidizer has an activation temperature of about 70° C. to about 150° C. In some embodiments, the oxidizer has an activation temperature of about 80° C. to about 150° C. In some embodiments, the oxidizer has an activation temperature of about 90° C. to about 150° C. In some embodiments, the oxidizer has an activation temperature of about 100° C. to about 150° C. In some embodiments, the oxidizer has an activation temperature of about 110° C. to about 150° C. In some embodiments, the oxidizer has an activation temperature of about 120° C. to about 150° C. In some embodiments, the oxidizer has an activation temperature of about 130° C. to about 150° C. In some embodiments, the oxidizer has an activation temperature of about 140° C. to about 150° C.

In some embodiments, the oxidizer has an activation temperature of about 20° C. to about 100° C. In some embodiments, the oxidizer has an activation temperature of about 30° C. to about 100° C. In some embodiments, the oxidizer has an activation temperature of about 40° C. to about 100° C. In some embodiments, the oxidizer has an activation temperature of about 50° C. to about 100° C. In some embodiments, the oxidizer has an activation temperature of about 60° C. to about 100° C. In some embodiments, the oxidizer has an activation temperature of about 70° C. to about 100° C. In some embodiments, the oxidizer has an activation temperature of about 80° C. to about 100° C. In some embodiments, the oxidizer has an activation temperature of about 90° C. to about 100° C.

In some embodiments, the oxidizer has an activation temperature of about 100° C. to about 150° C. In some embodiments, the oxidizer has an activation temperature of about 110° C. to about 150° C. In some embodiments, the oxidizer has an activation temperature of about 120° C. to about 150° C. In some embodiments, the oxidizer has an activation temperature of about 130° C. to about 150° C. In some embodiments, the oxidizer has an activation temperature of about 140° C. to about 150° C.

In some embodiments, the oxidizer has an activation temperature of about 20° C. to about 300° C. In some embodiments, the oxidizer has an activation temperature of about 100° C. to about 300° C. In some embodiments, the oxidizer has an activation temperature of about 150° C. to about 300° C.

In some embodiments, the composition comprises about 1 pounds per thousand gallons (pptg) to about 100 pptg oxidizer. In some embodiments, the composition comprises about 5 pptg to about 75 pptg oxidizer. In some embodiments, the composition comprises about 10 pptg to about 50 pptg oxidizer.

In some embodiments, the composition comprises about 5 pptg to about 100 pptg oxidizer. In some embodiments, the composition comprises about 10 pptg to about 100 pptg oxidizer. In some embodiments, the composition comprises about 20 pptg to about 100 pptg oxidizer. In some embodiments, the composition comprises about 30 pptg to about 100 pptg oxidizer. In some embodiments, the composition comprises about 40 pptg to about 100 pptg oxidizer. In some embodiments, the composition comprises about 50 pptg to about 100 pptg oxidizer. In some embodiments, the composition comprises about 60 pptg to about 100 pptg oxidizer. In some embodiments, the composition comprises about 70 pptg to about 100 pptg oxidizer. In some embodiments, the composition comprises about 80 pptg to about 100 pptg oxidizer. In some embodiments, the composition comprises about 90 pptg to about 100 pptg oxidizer.

In some embodiments, the composition comprises about 1 pptg to about 90 pptg oxidizer. In some embodiments, the composition comprises about 1 pptg to about 80 pptg oxidizer. In some embodiments, the composition comprises about 1 pptg to about 70 pptg oxidizer. In some embodiments, the composition comprises about 1 pptg to about 60 pptg oxidizer. In some embodiments, the composition comprises about 1 pptg to about 50 pptg oxidizer. In some embodiments, the composition comprises about 1 pptg to about 40 pptg oxidizer. In some embodiments, the composition comprises about 1 pptg to about 30 pptg oxidizer. In some embodiments, the composition comprises about 1 pptg to about 20 pptg oxidizer. In some embodiments, the composition comprises about 1 pptg to about 10 pptg. In some embodiments, the composition comprises about 1 pptg to about 5 pptg oxidizer.

In some embodiments, the composition is slickwater-based, linear gel-based, viscoelastic surfactant-based, or polymer-based gel-based.

In some embodiments, the composition is slickwater-based. Slickwater is a fracturing fluid comprising one or more proppants, one or more polymers, and one or more chemical breakers within the composition.

In some embodiments, the composition is slickwater-based, and comprises about 0.25 to about 4 pounds per gallon of proppant.

In some embodiments, the proppant comprises at least one member selected from the group consisting of river sand, 20/40 mesh sand, resin-coated sand, ceramic, sintered bauxite, and zirconium oxide. In some embodiments, the proppant comprises 20/40 mesh sand.

In some embodiments, the composition is slickwater-based, and comprises about 0.25 to about 10 gallons per thousand gallons of friction reducer. The friction reducer may be composed of synthetic polymer such as polyacrylamide.

In some embodiments, the composition is slickwater-based, and the breaker is an oxidizer.

In some embodiments, the composition is polymer-based gel-based. In some embodiments, the composition is linear gel-based. Linear gel is a type of fracturing fluid composed of water, a clay control agent, and a linear polymer. Linear based gels may comprise linear (uncrosslinked) polymers.

In some embodiments, the polymer comprises at least one member selected from the group consisting of guar, guar gum, derivatized-guar, carboxymethyl hydroxypropyl guar (CMHPG), carboxymethyl guar (CMG), hydroxypropyl guar (HPG), hydroxyethyl cellulose (HEC), carboxymethyl hydroxyethyl cellulose (CMHEC), and xanthan.

In some embodiments, the linear polymers are polysaccharides. In some embodiments, the polysaccharides comprise at least one member selected from the group consisting of guar, guar gum, derivatized-guar, carboxymethyl hydroxypropyl guar (CMHPG), carboxymethyl guar (CMG), hydroxypropyl guar (HPG), hydroxyethyl cellulose (HEC), carboxymethyl hydroxyethyl cellulose (CMHEC), and xanthan.

In some embodiments, the composition is viscoelastic surfactant-based. Viscoelastic surfactant-based compositions are viscous under shear forces but leave minimal residue. Viscoelastic surfactant-based compositions may comprise a water soluble salt and an organic stabilizing additive. In some embodiments, the water soluble salt comprises at least one member selected from ammonium chloride and potassium chloride. In some embodiments, the organic stabilizing additive is sodium salicylate.

In some embodiments, the composition further comprises at least one member of a disinfectant, a surfactant, a thickener, a scale inhibitor, an acid, a corrosion inhibitor, and a proppant.

In some embodiments, the composition further comprises a disinfectant. In some embodiments, the disinfectant comprises at least one member of glutaraldehyde, 2,2-dibromo-2-nitrilopropionamide (DBNPA, 2,2-dibromo-2-cyanoacetamide), 2-bromo-2-nitropropane-1,3-diol (bronopol), tetrakis(hydroxymethyl)phosphonium sulfate (THPS), dazomet (3,5-dimethyl-1,3,5-thiadiazinane-2-thione or “mylon”), chloromethylisothiazolinone (CMIT, or MCI, 5-chloro-2-methyl-3(2H)-isothiazolinone), and methylisothiazolinone (MIT, or MI, 2-methyl-3(2H)-isothiazolinone).

In some embodiments, the composition further comprises a surfactant. In some embodiments, the surfactant comprises at least one member of isopropanol and ammonium persulfate.

In some embodiments, the composition further comprises a thickener. In some embodiments, the thickener comprises at least one member of guar gum and hydroxyethyl cellulose.

In some embodiments, the composition further comprises a scale inhibitor. In some embodiments, the scale inhibitor comprises at least one member of ethylene glycol and sodium lauryl sulfate.

In some embodiments, the composition further comprises an acid. In some embodiments, the acid comprises at least one member of hydrochloric acid and muriatic acid.

In some embodiments, the composition further comprises a corrosion inhibitor. In some embodiments, the corrosion inhibitor is N,N-dimethylformamide.

In some embodiments, the composition further comprises a proppant. In some embodiments, the proppant comprises at least one member of silica sand, silica, sintered bauxite, and quartz sand.

In some embodiments, the composition comprises about 0.01 wt % to about 20.0 wt % nanoparticles and about 1 pptg to about 100 pptg oxidizer. In some embodiments, the composition comprises about 0.1 wt % to about 10.0 wt % nanoparticles and about 10 pptg to about 50 pptg oxidizer.

In some embodiments, the composition comprises:
about 0.01 wt % to about 20.0 wt % nanoparticles, wherein the nanoparticles comprise at least one member selected from silica, titanium oxide (TiO₂), zinc oxide (ZnO), aluminum oxide (Al₂O₃), cerium oxide (CeO₂), iron (III) oxide (Fe₂O₃), silver oxide (AgO), magnesium oxide (MgO), nickel oxide (NiO), zirconium oxide (ZrO), and cadmium oxide (CdO); and
about 1 pptg to about 100 pptg oxidizer, wherein the oxidizer comprises at least one member selected from a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

In some embodiments, the composition comprises:
about 0.1 wt % to about 10.0 wt % nanoparticles, wherein the nanoparticles comprise at least one member selected from silica, titanium oxide (TiO₂), zinc oxide (ZnO), aluminum oxide (Al₂O₃), cerium oxide (CeO₂), iron (III) oxide (Fe₂O₃), silver oxide (AgO), magnesium oxide (MgO), nickel oxide (NiO), zirconium oxide (ZrO), and cadmium oxide (CdO); and
about 10 pptg to about 50 pptg oxidizer, wherein the oxidizer comprises at least one member selected from a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

In some embodiments, the composition comprises:
about 0.01 wt % to about 20.0 wt % silica nanoparticles; and
about 1 pptg to about 100 pptg oxidizer, wherein the oxidizer comprises at least one member selected from a hypochlorite, a chlorite, a chlorate, a perchlorate, a hypobromite, a bromite, a bromate, and a perbromate.

In some embodiments, the composition comprises:
about 0.1 wt % to about 10.0 wt % silica nanoparticles; and about 10 pptg to about 50 pptg oxidizer, wherein the oxidizer comprises at least one member selected from a hypochlorite, a chlorite, a chlorate, a perchlorate, a hypobromite, a bromite, a bromate, and a perbromate.

In some embodiments, the composition comprises:
about 0.01 wt % to about 20.0 wt % silica nanoparticles; and
about 1 pptg to about 100 pptg oxidizer, wherein the oxidizer comprises at least one member selected from a chlorite and a bromate.

In some embodiments, the composition comprises:
about 0.1 wt % to about 10.0 wt % silica nanoparticles; and
about 10 pptg to about 50 pptg oxidizer, wherein the oxidizer comprises at least one member selected from a chlorite and a bromate.

In some embodiments, the composition comprises:
about 0.01 wt % to about 20.0 wt % silica nanoparticles; and
about 1 pptg to about 100 pptg oxidizer, wherein the oxidizer comprises at least one member selected from a chlorite and a bromate.

In some embodiments, the composition comprises:
about 0.1 wt % to about 10.0 wt % silica nanoparticles; and
about 10 pptg to about 50 pptg oxidizer, wherein the oxidizer comprises at least one member selected from LiClO₂, NaClO₂, KClO₂, Mg(ClO₂)₂, Ca(ClO₂)₂, Sr(ClO₂)₂, Ba(ClO₂)₂, LiBrO₃, NaBrO₃, KBrO₃, Mg(BrO₃)₂, Ca(BrO₃)₂, Sr(BrO₃)₂, Ba(BrO₃)₂, and NaClO.

In some embodiments, the composition comprises:
about 0.01 wt % to about 20.0 wt % wherein the nanoparticles comprise at least one member selected from silica, titanium oxide (TiO₂), zinc oxide (ZnO), aluminum oxide (Al₂O₃), cerium oxide (CeO₂), iron (III) oxide (Fe₂O₃), silver oxide (AgO), magnesium oxide (MgO), nickel oxide (NiO), zirconium oxide (ZrO), and cadmium oxide (CdO); and
about 1 pptg to about 100 pptg oxidizer, wherein the oxidizer has a standard reduction potential of about 0.50 V to about 2.00 V.

In some embodiments, the composition comprises:
about 0.1 wt % to about 10.0 wt % wherein the nanoparticles comprise at least one member selected from silica, titanium oxide (TiO₂), zinc oxide (ZnO), aluminum oxide (Al₂O₃), cerium oxide (CeO₂), iron (III) oxide (Fe₂O₃), silver oxide (AgO), magnesium oxide (MgO), nickel oxide (NiO), zirconium oxide (ZrO), and cadmium oxide (CdO); and
about 10 pptg to about 50 pptg oxidizer, wherein the oxidizer has a standard reduction potential of about 0.50 V to about 2.00 V.

In some embodiments, the composition comprises:
about 0.1 wt % to about 3.0 wt % wherein the nanoparticles comprise at least one member selected from silica, titanium oxide (TiO₂), zinc oxide (ZnO), aluminum oxide (Al₂O₃), cerium oxide (CeO₂), iron (III) oxide (Fe₂O₃), silver oxide (AgO), magnesium oxide (MgO), nickel oxide (NiO), zirconium oxide (ZrO), and cadmium oxide (CdO); and
about 10 pptg to about 50 pptg oxidizer, wherein the oxidizer has a standard reduction potential of about 0.50 V to about 2.00 V.

In some embodiments, the composition may be used to form fractures in a rock formation. In some embodiments, the method comprises injecting a composition into a rock formation to form fractures in the rock formation, wherein the composition comprises nanoparticles and an oxidizer, wherein the composition is a fluid.

In some embodiments, the method comprises:
blending an oxidizer into a first fluid to form a fluid comprising an oxidizer;
blending nanoparticles into a second fluid to form a fluid comprising nanoparticles;
injecting the fluid comprising an oxidizer and the fluid comprising nanoparticles into a rock formation to form the composition; and
creating fractures in the rock formation.

In some embodiments, the fluid comprising the oxidizer and the fluid comprising the nanoparticles are injected into the rock formation simultaneously.

In some embodiments, the fluid comprising the oxidizer and the fluid comprising the nanoparticles are injected into the rock formation sequentially.

In some embodiments, the fluid comprising the oxidizer is injected into the rock formation before the fluid comprising the nanoparticles oxidizer is injected into the rock formation.

In some embodiments, the fluid comprising the oxidizer is injected into the rock formation after the fluid comprising the nanoparticles oxidizer is injected into the rock formation.

In some embodiments, the fluid comprising the oxidizer and the fluid comprising the nanoparticles are injected into the rock formation alternately.

### EMBODIMENTS

Embodiment 1. A composition comprising:
nanoparticles; and
an oxidizer;
wherein the composition is a fluid.

Embodiment 2. The composition of embodiment 1, wherein the nanoparticles are uncrosslinked.

Embodiment 3. The composition of embodiment 1 or 2, wherein the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), and cadmium oxide (CdO).

Embodiment 4. The composition of any one of embodiments 1-3, wherein the nanoparticles comprise silica.

Embodiment 5. The composition of any one of embodiments 1-4, wherein the composition comprises 0.1 wt % to 10.0 wt % nanoparticles.

Embodiment 6. The composition of any one of embodiments 1-4, wherein the composition comprises 0.1 wt % to 3.0 wt % nanoparticles.

Embodiment 6. The composition of any one of embodiments 1-5, wherein the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

Embodiment 7. The composition of any one of embodiments 1-5, wherein the oxidizer comprises at least one member selected from the group consisting of a hypochlorite, a chlorite, a chlorate, a perchlorate, a hypobromite, a bromite, a bromate, and a perbromate.

Embodiment 8. The composition of any one of embodiments 1-5, wherein the oxidizer comprises at least one member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, Ba(BrO₃)₂, F₂, Cl₂, MgO₂, CaO₂, NaNO₂, NaNO₃, Na₂S₂O₈, Na₂B₄O₇, Na₂H₃CO₆, H₂O₂, NaClO, Ca(IO₃)₂, KIO₃, KH(IO₃)₂, NaIO₄, KIO₄, Na₂CrO₄, Na₂Cr₂O₇, K₂Cr₂O₇, NaMnO₄, and KMnO₄.

Embodiment 9. The composition of any one of embodiments 1-5, wherein the oxidizer comprises at least one member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, and Ba(BrO₃)₂.

Embodiment 10. The composition of any one of embodiments 1-9, wherein the oxidizer has a standard reduction potential of greater than 0.40 V.

Embodiment 11. The composition of any one of embodiments 1-9, wherein the oxidizer has a standard reduction potential of 0.40 V to 3.00 V.

Embodiment 12. The composition of any one of embodiments 1-9, wherein the oxidizer has a standard reduction potential of 0.50 V to 2.00 V.

Embodiment 13. The composition of any one of embodiments 1-9, wherein the oxidizer has an activation temperature of under 150° C.

Embodiment 14. The composition of any one of embodiments 1-13, wherein the composition comprises 1 pounds per thousand gallons (pptg) to 100 pptg oxidizer.

Embodiment 15. The composition of any one of embodiments 1-13, wherein the composition comprises 10 pptg to 50 pptg oxidizer.

Embodiment 16. The composition of any one of embodiments 1-15, wherein the composition is slickwater-based, linear gel-based, viscoelastic surfactant-based, or polymer-based gel-based.

Embodiment 17. The composition of embodiment 1, comprising:
0.1 wt % to 10.0 wt % silica nanoparticles; and
10 pptg to 50 pptg oxidizer, wherein the oxidizer comprises a member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, and Ba(BrO₃)₂.

Embodiment 18. A method, comprising:
injecting the composition of any one of embodiments 1-17 into a rock formation to form fractures in the rock formation.

Embodiment 19. The method of embodiment 18, wherein:
the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), cadmium oxide (CdO); and
the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

Embodiment 20. A method, comprising:
blending an oxidizer into a first fluid to form a fluid comprising an oxidizer;
blending nanoparticles into a second fluid to form a fluid comprising nanoparticles;
injecting the fluid comprising an oxidizer and the fluid comprising nanoparticles into a rock formation to form the composition; and
creating fractures in the rock formation.

Embodiment 21. The method of embodiment 20, wherein:
the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), cadmium oxide (CdO); and
the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

### EXAMPLES

### Example 1

Examples of compositions are prepared by combining an oxidizer and nanoparticles. The oxidizer is at a concentration of about 1 to about 100 pptg, or about 10 to about 50 pptg. The nanoparticles will be added at a concentration of about 1 to about 3 wt %.

Specific oxidizers and nanoparticles are evaluated at varying concentrations to determine their characteristics and synergy.

1. A composition comprising:
nanoparticles; and
an oxidizer;
wherein the composition is a fluid.

2. The composition of claim 1, wherein the nanoparticles are uncrosslinked.

3. The composition of claim 1, wherein the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), and cadmium oxide (CdO).

4. The composition of claim 1, wherein the nanoparticles comprise silica.

5. The composition of claim 1, wherein the composition comprises 0.1 wt % to 10.0 wt % nanoparticles.

6. The composition of claim 1, wherein the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

7. The composition of claim 1, wherein the oxidizer comprises at least one member selected from the group consisting of a hypochlorite, a chlorite, a chlorate, a perchlorate, a hypobromite, a bromite, a bromate, and a perbromate.

8. The composition of claim 1, wherein the oxidizer comprises at least one member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, Ba(BrO₃)₂, F₂, Cl₂, MgO₂, CaO₂, NaNO₂, NaNO₃, Na₂S₂O₈, Na₂B₄O₇, Na₂H₃CO₆, H₂O₂, NaClO, Ca(IO₃)₂, KIO₃, KH(IO₃)₂, NaIO₄, KIO₄, Na₂CrO₄, Na₂Cr₂O₇, K₂Cr₂O₇, NaMnO₄, and KMnO₄.

9. The composition of claim 1, wherein the oxidizer comprises at least one member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, and Ba(BrO₃)₂.

10. The composition of claim 1, wherein the oxidizer has a standard reduction potential of greater than 0.40 V.

11. The composition of claim 1, wherein the oxidizer has a standard reduction potential of 0.40 V to 3.00 V.

12. The composition of claim 1, wherein the oxidizer has an activation temperature of under 150° C.

13. The composition of claim 1, wherein the composition comprises 1 pounds per thousand gallons (pptg) to 100 pptg oxidizer.

14. The composition of claim 1, wherein the composition comprises 10 pptg to 50 pptg oxidizer.

15. The composition of claim 1, wherein the composition is slickwater-based, linear gel-based, viscoelastic surfactant-based, or polymer-based gel-based.

16. The composition of claim 1, comprising:
0.1 wt % to 10.0 wt % silica nanoparticles; and
10 pptg to 50 pptg oxidizer, wherein the oxidizer comprises a member selected from the group consisting of LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, and Ba(BrO₃)₂.

17. A method, comprising:
injecting the composition of claim 1 into a rock formation to form fractures in the rock formation.

18. The method of claim 17, wherein:
the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), cadmium oxide (CdO); and
the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.

19. A method, comprising:
blending an oxidizer into a first fluid to form a fluid comprising an oxidizer;
blending nanoparticles into a second fluid to form a fluid comprising nanoparticles;
injecting the fluid comprising an oxidizer and the fluid comprising nanoparticles into a rock formation to form the composition; and
creating fractures in the rock formation.

20. The method of claim 19, wherein:
the nanoparticles comprise at least one member selected from the group consisting of silica, titanium oxide (TiO₂), zinc oxide (ZnO), aluminum oxide (Al₂O₃), cerium oxide (CeO₂), iron oxide (Fe₂O₃), silver oxide (AgO), magnesium oxide (MgO), nickel oxide (NiO), zirconium oxide (ZrO), cadmium oxide (CdO); and
the oxidizer comprises at least one member selected from the group consisting of a hypochlorite, a chlorite, a chlorate, a perchlorate, a hypobromite, a bromite, a bromate, a perbromate, a peroxide, a nitrite, a nitrate, a persulfate, a tetraborate, a percarbonate, a hypochlorite, an iodate, a periodate, a chromate, a dichromate, and a permanganate.
